(19) United States
(12) Patent Application Publication
(10) Pub. No.: US 2005/0192926 A1
(43) Pub. Date: Sep. 1, 2005

(54) Hierarchical visualization of a semantic network

(75) Inventors: Shi Xia Liu, Beijing (CN); Zhong Su, Beijing (CN); Yue Pan, Beijing (CN); Li Zhang, Beijing (CN)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/060,471

(22) Filed: Feb. 17, 2005

(30) Foreign Application Priority Data
Feb. 18, 2004 (CN) 200410004288.6

(51) Int. Cl. G06F 7/00

(52) U.S. Cl. 707/1

(57) ABSTRACT

The present invention provides methods, systems and apparatus for generating a visualized hierarchy model for a semantic network, and for browsing a semantic network and a semantic network browser. An example of a semantic network comprises a plurality of concepts and a plurality of relation instances each for connecting two concepts. The method for generating a visualized hierarchy model for a semantic network comprises: determining the similarities among said concepts based on the connection relations of said plurality of concepts in said semantic network; and clustering the concepts with high similarities one by one, so as to form a visualized hierarchy model of said semantic network.

### FIELD OF THE INVENTION

The present invention relates to data processing techniques, in particular, to the techniques of performing hierarchical visualization for semantic network by utilizing a computer.

### BACKGROUND OF THE INVENTION

A semantic network is an important method for representing knowledge in artificial intelligence and knowledge engineering, it is widely used in defining and describing domain knowledge. A semantic network generally comprises nodes and arcs (connections), wherein node represents event and concept, while arc represents the relation between nodes. FIG. 1 shows an example of a visualized semantic network, which contains a plurality of concepts (represented by nodes of triangles, squares, pentagons and polygons in the figure) and connections between the concepts (represented by lines in the figure).

A semantic network has the following advantages:
1. A semantic network has relatively strong representation ability, it is able to represent binary relations in a predicate logic and to represent multiple relations also, if they have been converted into binary relations;
2. A semantic network has features of visibility and explicitness in knowledge representation, and programs can directly search a semantic network and manipulate the data therein. Currently, a semantic network has been widely used in knowledge-based computer systems, such as enterprise organization management, intelligent search engine and expert system.

However, due to the limitation in display screen, the amount of content in a semantic network may exceed the range that one screen can display. In the prior art, this situation is handled through zooming out displayed image/text to the extent that can be accommodated within one screen and then perform zooming in/snapping according to user-selected area. However, when display in zooming out, since the displayed text can't be seen clearly, the operation is not convenient. In addition, since the important and unimportant concepts or relations will be zoomed out in same scale, it is difficult for a user to select desired content to browse progressively and gradually.

### SUMMARY OF THE INVENTION

In order to solve the above mentioned problems, according to one aspect of the present invention, there is provided methods for generating a visualized hierarchy model for a semantic network. A semantic network comprises a plurality of concepts and a plurality of relation instances each for connecting two concepts, characterized in that the method comprises: determining the similarities among the concepts based on the connection relations of the plurality of concepts in the semantic network; and clustering the concepts with high similarities one by one, so as to form a visualized hierarchy model of the semantic network.

According to another aspect of the present invention, there is provided a method for browsing a semantic network comprising: using the above-described method for generating a visualized hierarchy model for a semantic network to generate the visualized hierarchy model of the semantic network; and displaying the content of a corresponding level of the visualized hierarchy model of the semantic network in response to user's selection.

According to another aspect of the present invention, there is provided an apparatus for generating a visualized hierarchy model for a semantic network.

According to another aspect of the present invention, there is provided a semantic network browser.

### BRIEF DESCRIPTION OF THE DRAWINGS

The above mentioned features, advantages and aspects will be better understood through the following description of the embodiments of the present invention with reference to the drawings, in which:

FIG. 1A illustrates an example of a visualized semantic network, FIGS. 1B and 1C illustrate examples of respective level descriptions of visualized hierarchy model of a semantic network generated by the method for generating a visualized hierarchy model for a semantic network according to an embodiment of the present invention;

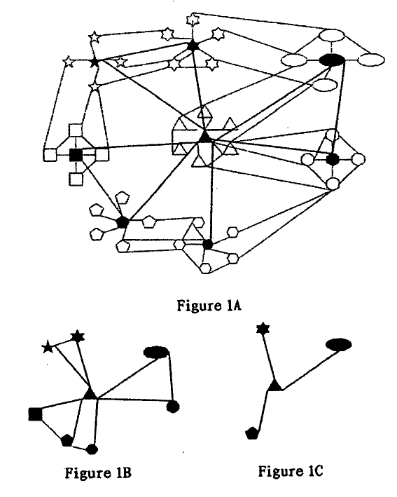

FIG. 2 is a flowchart showing a method for generating a visualized hierarchy model for a semantic network according to an embodiment of the present invention;

FIG. 3 is a flowchart showing a method for browsing a semantic network according to an embodiment of the present invention;

FIG. 4 is a block diagram illustrating an apparatus for generating a visualized hierarchy model for a semantic network according to an embodiment of the present invention; and

FIG. 5 is a block diagram illustrating a semantic network browser according to an embodiment of the present invention.

### DETAILED DESCRIPTION OF THE INVENTION

The present invention provides methods, apparatus and systems for generating a visualized hierarchy model for a semantic network. An example of a semantic network comprises a plurality of concepts and a plurality of relation instances each for connecting two concepts. A method comprises: determining the similarities among the concepts based on the connection relations of the plurality of concepts in the semantic network; and clustering the concepts with high similarities one by one, so as to form a visualized hierarchy model of the semantic network.

The present invention also provides a method for browsing a semantic network comprising: using the above-described method for generating a visualized hierarchy model for a semantic network to generate the visualized hierarchy model of the semantic network; and displaying the content of a corresponding level of the visualized hierarchy model of the semantic network in response to user's selection.

The present invention also provides an apparatus for generating a visualized hierarchy model for a semantic network, the semantic network comprising a plurality of concept and a plurality of relation instances each for connecting two concepts, characterized in that the apparatus comprises: a concept similarity calculation unit for determining the similarities among the concepts based on the connection relations among the plurality of concepts in the semantic network; a concept clustering unit for clustering concepts with high similarities; and a hierarchy forming unit for forming visualized hierarchy model of the semantic network level by level utilizing the concept clustering unit.

The present invention also provides a semantic network browser. The semantic network includes a plurality of concepts and a plurality of relation instances for connecting two concepts. The method is characterized in that, the browser comprising: the above-mentioned apparatus for generating a visualized hierarchy model for a semantic network; a graph conversion unit for converting the visualized hierarchy model generated by the apparatus for generating a hierarchy model of a semantic network into a graph mode to display; and a level switching unit for switching between the levels of the hierarchy model and controlling the graph conversion unit to display, in response to user's selection.

Next, detailed description will be given to the advantageous embodiments of the present invention with reference to the drawings.

Method for Generating a Visualized Hierarchy Model for a Semantic Network

The present invention provides a method for generating a visualized hierarchy model for a semantic network. In order to understand the present application better, some terms used in the description will be explained before describing embodiments of the present invention.

Concept set: concept set is a semantic set C={c₁, . . . , cₙ}, where each element in C is a specific semantic object and called as concept or concept item. For instance, elements in concept set may be names, places and so on.

Relation set: relation set R={r₁, . . . , rₘ}, where each element in R is a specific predicate (relation type) to tell the semantic connection between two concept item and is called as relation item or relation type. For instance, examples of elements in relation set may be “relation between higher and lower levels”, “relation between husband and wife” and so on.

Triple: a triple t=(subject, predicate, object, w), where subject, object∈C, predicate∈R, it can be considered as a directed link with one nodes at each end of it. Each connection embodied by a triple may be considered as a relation instance of corresponding relation type in relation set. Here w is “definition weight”, representing the importance or reliability of corresponding triple. w is inputted by the user or obtained through calculation when establishing the semantic network. w has a value between 0 and 1 in the present embodiment.

Semantic network: a semantic network is composed by a set of triples, S={t₁, . . . , tₖ}. Because each triple can be considered as a directed link with two nodes at the end and some triples can possibly share the same concept item and thus a directed graph can be generated based on the triple set. So we call it a semantic network.

Neighbor concept set: the set is composed of all concepts associated with c in semantic network S. For a given concept item c, the neighbor concept set is defined by:
NC(c)={nc₁, . . . , ncₘ|i≠jncᵢ≠ncⱼ, ∀ncᵢ∃t∈S, ((subject(t)=ncᵢ∩object(t)=c)∪(subject(t)=c∩object(t)=ncᵢ)=true)}

Neighbor concept vector: a vector representing connection relation between a concept c and other concepts in the semantic network. If there are N concept items in concept set and consider each concept item in the concept set as one component in N-dimensional vector space, according to an embodiment of the present invention, the N-dimensional neighbor concept vector v(c) can be calculated according to following discipline: for a component of v(c), if its corresponding concept item has connection with c, that is, it exists triple between these two concepts, then using the corresponding triple weight as the value of that dimension; if there are more than one triple between these two concepts, the max value of the triple weight will be used as the dimension value; if there is no triple between these two concepts, then the value of that dimension is set to 0. Furthermore, when there is no weight in triple, if it exists triple between these two concepts, then the value of that dimension will be set to 1 or the number of the triples; if there is no triple between these two concepts, then the value of that dimension will be set to 0.

Relation type feature vector: a vector representing the features of a relation type r in semantic network. If the semantic network contains N concepts, then the relation type feature vector v(r) is a 2*N dimensional vector v(r)=[wₛ₁, wₛ₂, . . . , w_{sN}, Wₒ₁, wₒ₂, . . . , w_{oN}]. The first N items correspond to respective concepts as the subjects of all the relation instances of relation type r, the last N items correspond to respective concepts as the objects of all the relation instances of relation type r. According to an embodiment of the present invention, the value of each component can be calculated with term-frequency, that is, the number of occurrence a corresponding concept appears as subject or object of the relation type r in a semantic network.

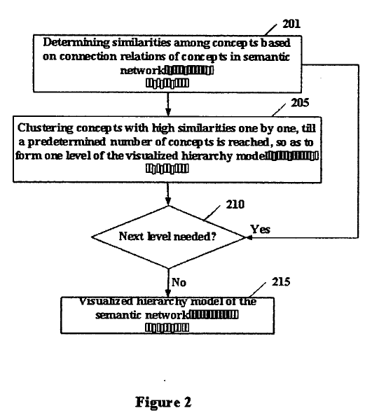

FIG. 2 is a flowchart showing a method for generating a visualized hierarchy model for a semantic network according to an embodiment of the present invention. As shown in FIG. 2, first at Step 201, determining similarities among the concepts based on the connection relations in the semantic network. Specifically, calculating a neighbor concept vector v(c) for each concept and determining the similarities among concepts according to the calculated neighbor concept vectors. Consider pseudo-code fragment 1:
Pseudo-code fragment 1
Algorithm 1: calculate the similarity between two concept items in semantic network.

Sim(c1,c2)

{

NC2=NC(c₂);
If(c₁ not in NC₂)

return 0;

return( cos(v(c₁),v(c₂));

}

Pseudo-code fragment 1 illustrates an algorithm for determining the similarity based on the neighbor concept vectors v(c1) and v(c2) of two concept items. In this algorithm, first a determination is made as to whether the two concept items are neighbors; if not, return 0 and if yes, return the cosine of the angle between the two vectors,

$$cos ( {w}_{i} , {w}_{j} ) = \frac{{w}_{i} \cdot {w}_{j}}{\vert {w}_{i} \vert \times \vert {w}_{j} \vert} .$$

The present invention is not limited to the algorithm in code fragment 1, other approaches can be utilized to represent the similarity between two concept items.

Next, at Step 205, concepts with high similarities are clustered one by one till a predetermined number, so as to form one level in the visualized hierarchy model. Consider pseudo-code fragment 2:
Pseudo-code fragment 2
Algorithm 2: clustering on semantic network S, there are n concept elements in S, cluster them into m nodes, where m<n

Clustering(S, m)

```
{
    Get all triples in S;
    Number=triple number;
    while(Number>m)
    {
        calculate the similarity of subjects and objects of all triples;
        find the most similar pair (a, b), where a and b are concept items
        of a specific triple; create a new concept item c; //the name of
        c is the combination of the names of a and b
        merge a ,b to node c;
        update those triples which contain a or b as one of their
        components (subject or object);
        //replace a, b with c;
        Number−−;
        }
}
```

Pseudo-code fragment 2 illustrates an algorithm for clustering concept items one by one based on similarity till a predetermined number.

In that algorithm, first, all triples in the semantic network are taken out and the concept pair (a, b) with highest similarity is found using the above-mentioned method for calculating similarity, where a and b are two concept items belonging to a triple. Next, a new concept item c is created, a and b are merged into c and all ripples containing a and b are updated, and a and b are substituted by c. This merge process is repeatedly performed until concept items are reduced to a predetermined number m. Here, the predetermined number m is the number of concepts desires to be preserved in the level in hierarchy model. It can be specified by user or calculated by system based on concept and relation instance (or the number of triples) in the semantic network, the approach for calculating the number of levels in visualized hierarchy model and the predetermined number m in clustering each level will be described in detail later.

Next, at Step 210, a determination is made as to whether the clustering of the next level is needed; if so, the level just obtained through clustering is taken as a basis and go back to continue with similarity determination and clustering (step 201 and 205); if the determination is that there is no need to perform next level clustering, then proceed to step 215, constructing the visualized hierarchy model with respective levels obtained through clustering and the original semantic network.

In the present embodiment, the number of levels in the visualized hierarchy model and the number of concepts or triples (relation instances) contained in each level may be set by user according to his/her own preference, or be preset to different modes for user's selection, or may be automatically calculated according to the number of entities (concept item nodes and relation connections) that may be displayed within one display screen and the number of concept items and relation instances in the semantic network. For instance, assume that the semantic network contains N₁ concept items and N₂ relation instances and one screen page can display M1 concept item nodes and M2 relation connections, then the number of levels k of generated visualized hierarchy model may be calculated through following formulas:
Level k satisfies:
   M₁+M₁²+Λ+M₁^{k}≦N₁ M₂+M₂²+Λ+M₂^{k}≦N₂,
that is,

$$k = max ( {log}_{{M}_{1}} \frac{( {N}_{1} + 1 ) ( {M}_{1} - 1 ) + {M}_{1}}{{M}_{1}} + 1 , {log}_{{M}_{2}} \frac{( {N}_{2} + 1 ) ( {M}_{2} - 1 ) + {M}_{2}}{{M}_{2}} + 1 ) \qquad ( 1 )$$

Accordingly, the number of concept items at each level may be:
mᵢ=max(M₁ⁱ,M₂ⁱ)(i=1Λk) (2)

Of course, any other methods that may be conceived by those skilled in the art can be used to calculate the number of levels in a hierarchy model and the number of concept items contained in respective levels.

By using above-mentioned method of the present embodiment, it is possible to generate a visualized hierarchy model based on the feature information contained in the semantic network itself.

According to another embodiment of the present invention, before the step of determining the similarities among concepts based on the connection relations of concepts in a semantic network (Step 201 of FIG. 2), a relation type that a user is interested in is provided by the user first as primary relation type. Then, according to the similarity between each relation type in the semantic network and the primary relation type, a ranking value is specified for each relation type. Consider pseudo-code fragment 3:
Pseudo-code fragment 3

Algorithm 3: calculate the similarity between two relation types in semantic network.

Sim (r₁,r₂)
{
return( cos(v(r₁)),v(r₂));
}

Pseudo-code fragment 3 illustrates an algorithm for determining the similarity based on the feature vectors of relation type, v(r1) and v(r2) of two relation types.

Then, in the step of determining the similarities among concepts based on the connection relations of concepts in a semantic network, specifically, when calculating a neighbor concept vector v(c) for each concept, the product of triple weight and ranking value is taken as the value of each component. For instance, for a component of v(c), if there is a connection between the corresponding concept item and c, that is, there exists a triple between these two concepts, then the product of corresponding triple weight and the ranking value of that relation type is taken as the value for that dimension; if there are a plurality of triples between these two concepts, then the product of max triple weight in these triples and the ranking value of that relation type is taken as the value for that dimension; if there is no triple between these two concepts, the value of that dimension will be set to 0.

Alternatively, when there is no weight recorded in triple or if there is a triple between these two concepts, then the value of that dimension can be set as ranking value of corresponding relation type or the number of triples multiplied by ranking value of corresponding relation type (in case of a plurality of triples); if there is no triple between these two concepts, then set the value of that dimension to 0.

Method for Browsing a Semantic Network

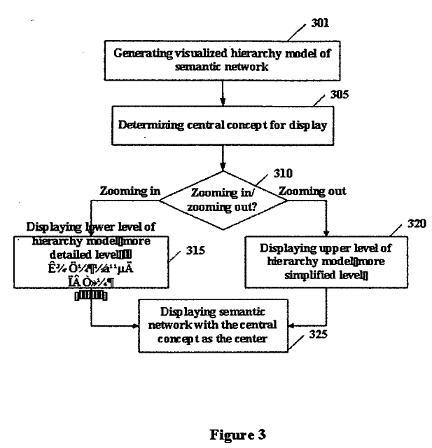

Under the same inventive concept, the present invention further provides a method for browsing a semantic network. FIG. 3 is a flowchart of the method for browsing a semantic network according to an embodiment of the present invention.

As shown in FIG. 3, first at step 301, using the method described above for generating a visualized hierarchy model for a semantic network to generate visualized hierarchy model for the semantic network to be browsed.

Then at step 305, a current central concept (node) is determined. During a user is browsing a semantic network, the user may select a desired node or region to browse and zoom in or zoom out. This step can determine the central concept (node) in response to user's selection or automatically determine a central concept node just when the user begins browsing or before selecting a node or region. Here, the present invention has no special limitation in the way of determining the central concept node, for instance, it may be a node in central position displayed by the semantic network, or a node in the most simplified level in the visualized hierarchy model.

Next, at step 310, a determination is made as to whether the user has zoomed in (more detailed) or zoomed out (more simplified). If the user has selected zoom in (more detailed), then step 315 is performed, switching to display more detailed level (lower level) of the visualized hierarchy model; if the user has selected zoom out (more simplified), then step 320 is performed, switching to display more simplified level (higher level) of the visualized hierarchy model.

After step 315 and step 320, the process proceeds to step 325, displaying the central concept determined above as the center. When switching to display hierarchy model, there may occur a case in which there is no above determined central concept in the current level, for instance, due to a and b are merged into c. In this case, it is needed to display related concept nodes (a, b and c are related) as the center. In addition, when the content of that level exceeds the range of display, it is further needed to cut off the part that is out of the range.

By using the above-described method of the present embodiment, it is possible to generate visualized hierarchy model based on the feature information contained in the semantic network itself so as to overcome the difficulty in browsing a huge semantic network on a screen. Since this hierarchy model is constructed based on the features of the semantic network itself, it can ensure that the original semantic network is truly summarized without user's manual operations. Furthermore, if combined with user-specified primary relation type, the hierarchy model can meet users' needs better and become more specific.

An Apparatus for Generating a Visualized Hierarchy Model for a Semantic Network

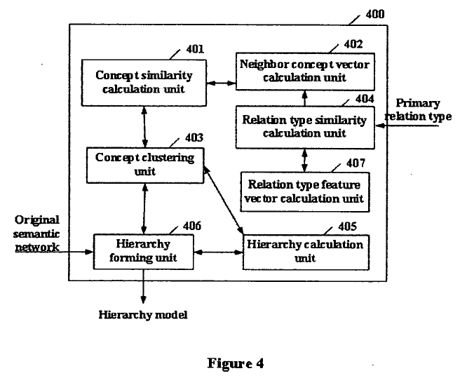

Under the same inventive concept, the present invention further provides an apparatus for generating a visualized hierarchy model for a semantic network. FIG. 4 is a block diagram illustrating an apparatus for generating a visualized hierarchy model for a semantic network according to an embodiment of the present invention.

As shown in FIG. 4, the apparatus 400 for generating a visualized hierarchy model for a semantic network comprises: a concept similarity calculation unit 401 for determining the similarities among concepts based on connection relations between concepts in the semantic network; a concept clustering unit 403 for clustering concepts with high similarities; and a hierarchy forming unit 406 for forming a visualized hierarchy model of the semantic network level by level using the concept clustering unit.

Furthermore, the apparatus 400 for generating a visualized hierarchy model for a semantic network further comprising: a neighbor concept vector calculation unit 402 for calculating neighbor concept vector of a concept, the concept similarity calculation unit 401 can utilize neighbor concept vectors to calculate the correlations (similarities) among concepts, the method of calculating neighbor concept vector and concept similarity has been explained above and will not be described here; a hierarchy calculation unit 405 for calculating the number of levels in the hierarchy model to be generated and the number of concepts in each level, according to the number of concepts and relation instances in the original semantic network and the max capacity of the screen, here the calculation method has also been explained above and will not be described here.

Furthermore, the apparatus 400 for generating a visualized hierarchy model for a semantic network further comprising: a relation type similarity calculation unit 404 for calculating the similarity between the user-specified primary relation type and each relation type in the semantic network, and relation type similarity is taken into consideration by the neighbor concept vector calculation unit when calculating neighbor concept vectors; a relation type feature vector calculation unit 407 for calculating the relation type feature vector for each relation type in the semantic network. Each component of the feature vector of the relation type corresponds to each concept in the semantic network and is calculated based on the connection instance of the relation type associated with that concept. The feature vectors of relation type and the method that takes the relation type similarity into consideration when calculating neighbor concept vector have been described above and will not be repeated here.

By using apparatus 400 for generating a visualized hierarchy model for a semantic network of the present embodiment, the method described above for generating a visualized hierarchy model for a semantic network may be implemented so as to generate visualized hierarchy model of semantic network and make specific concept combination based on the user-specified primary relation type.

Semantic Network Browser

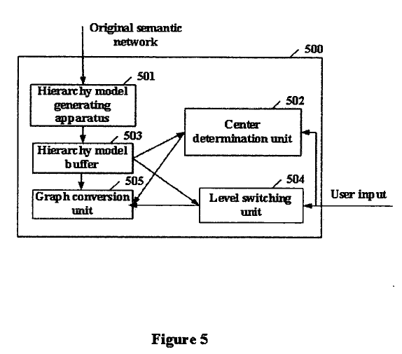

Under the same inventive concept, the present invention further provides a semantic network browser. FIG. 5 is a block diagram illustrating a semantic network browser according to an embodiment of the present invention.

As shown in FIG. 5, the semantic network browser comprises: the apparatus for generating a visualized hierarchy model for a semantic network as described in the above embodiment, it is named as hierarchy model generating apparatus 400 in the present embodiment for simplicity; a hierarchy model buffer 503 for temporarily storing the visualized hierarchy model generated by the hierarchy model generating apparatus 400; a graph conversion unit 505 for displaying the visualized hierarchy model generated by the hierarchy model generating apparatus to the user in graph mode, specifically, the graph conversion unit 505 is controlled by level switching unit 504 and center determination unit 502 which will be described later, and display the proper level and proper location to the user; a level switching unit 504 for switching between respective levels of the hierarchy model and controlling the graph conversion unit in display in response to user's selection; a center determination unit for determining the central concept node after switching the level of the hierarchy model. How to switch between respective levels of the hierarchy model in response to user's operations and how to determine the central concept node have been described above and will not be repeated here.

By using the semantic network browser 500 of the present embodiment, the method described above for browsing a semantic network may be implemented to generate visualized hierarchy model based on the feature information contained in the semantic network itself, so as to overcome the difficulty in browsing a huge semantic network on a screen. Since this hierarchy model is constructed based on the features of the semantic network itself, it can ensure that the original semantic network is truly summarized without user's manual operations.

The above described apparatus for generating a visualized hierarchy model for a semantic network and semantic network browser of the present invention, as well as their respective components, may be implemented in the form of hardware and software, and may be combined with other apparatus as needed, for example, they can be implemented on a personal computer, a notebook computer, a palmtop computer, a PDA, a word processor and other equipment with computing functionality.

Though a method and apparatus for generating a visualized hierarchy model for a semantic network, a method for browsing a semantic network and a semantic network browser have been described in details with some exemplary embodiments, these embodiments are not exhaustive. Those skilled in the art may make various variations and modifications within the spirit and scope of the present invention. Therefore, the present invention is not limited to these embodiments, rather, the scope of the present invention is only defined by the appended claims.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method comprising generating a visualized hierarchy model for a semantic network, said semantic network comprises a plurality of concepts and a plurality of relation instances each for connecting two concepts, characterized in that the step of generating comprises:
determining similarities among said concepts based on connection relations of said plurality of concepts in said semantic network; and
clustering the concepts with high similarities one by one, so as to form a visualized hierarchy model of said semantic network.

2. The method according to claim 1, characterized in that the step of determining the similarities among said concepts comprises:
calculating a neighbor concept vector for each said concept, said vector represents the connection relation between said concept and other concepts in said semantic network; and
calculating the similarity between two concepts based on the angle between the neighbor concept vectors of said two concepts.

3. The method according to claim 2, characterized in that the step of calculating the similarity between two concepts based on the angle between the neighbor concept vectors of said two concepts comprises:
utilizing the dot product of the neighbor concept vectors of said two concepts to calculate the angle between them, the smaller the angle, the higher the similarity between said two concepts.

4. The method according to claim 1, characterized in that the step of clustering concepts with high similarities one by one so as to form visualized hierarchy model of said semantic network comprises:
merging two concepts with the highest similarity connected by a relation instance; and
repeating above step of merging two concepts, till a predetermined number of concepts are left, so as to form one level of said visualized hierarchy model.

5. The method according to claim 4, characterized in that the step of clustering concepts with high similarities one by one so as to form visualized hierarchy model of said semantic network further comprises:
repeating above steps of merging two concepts and forming one level of said visualized hierarchy model, so as to form a hierarchy model having a plurality of levels.

6. The method according to claim 4, characterized in that said step of merging two concepts comprises:
creating a new concept to replace said two concepts;
merging said two concepts into said new concept; and
updating the relation instance associated with said two concepts using said new concept.

7. The method according to claim 2, characterized in that the step of calculating a neighbor concept vector for each concept comprises:
taking each concept in said semantic network as a dimension, if there is a relation instance between said concept and the concept being calculated the vector, the component is set to 1, otherwise, the component is set to 0.

8. The method according to claim 2, characterized in that each said relation instance is assigned with a connection weight and said step of calculating a neighbor concept vector for each concept comprises:
taking each concept in said semantic network as a dimension, if there is a relation instance between said concept and the concept being calculated the vector, then the component is calculated based on the weight of said relation instance, and if there is no relation instance, the component is set to 0.

9. The method according to claim 2, characterized in that a primary relation type is specified by a user and said step of calculating a neighbor concept vector for each concept comprises:
calculating the similarity between each relation type in said semantic network and said primary relation type specified by the user;
taking each concept in said semantic network as a dimension, if there is a relation instance between said concept and the concept being calculated the vector, then the component is calculated based on the weight of that relation instance and said similarity of relation types, and if there is no relation instance, the component is set to 0.

10. The method according to claim 8, characterized in that the step of calculating the similarity between each relation type in said semantic network and said primary relation type specified by the user comprises:
calculating a relation type feature vector of said relation type in said semantic network, each component in said relation type feature vector corresponds to each concept in said semantic network and is calculated based on the relation instances of said relation type associated with said concept; and
calculating the similarity between said relation type and said user-specified primary relation type based on the angle between the relation type feature vector of said relation type and the relation type feature vector of said user-specified primary relation type.

11. A method comprising browsing a semantic network, said semantic network comprising a plurality of concept and a plurality of relation instances each for connecting two concepts, characterized in that said step of browsing comprises:
using the method according to claim 1 to generate the visualized hierarchy model of said semantic network; and
displaying the content of a corresponding level of the visualized hierarchy model of said semantic network in response to user's selection.

12. The method for browsing a semantic network according to claim 11, characterized in that said step of displaying the content of a corresponding level of the visualized hierarchy model of said semantic network comprises:
determining a central concept for display;
when the user selects zoom in, displaying the content of a more detailed level of the visualized hierarchy model of said semantic network, and taking the above determined central concept as the center; and
when the user selects zoom out, displaying the content of a more simplified level of the visualized hierarchy model of said semantic network, and taking the above determined central concept as the center.

13. The method for browsing a semantic network according to claim 12, characterized in that said step of displaying the content of a corresponding level of the visualized hierarchy model of said semantic network further comprises:
if said central concept does not exist in the level to be displayed, taking a concept related to the central concept as the center for display.

14. An apparatus for generating a visualized hierarchy model for a semantic network, said semantic network comprising a plurality of concept and a plurality of relation instances each for connecting two concepts, characterized in that said apparatus comprises:
a concept similarity calculation unit for determining the similarities among said concepts based on the connection relations among said plurality of concepts in said semantic network;
a concept clustering unit for clustering concepts with high similarities; and
a hierarchy forming unit for forming visualized hierarchy model of said semantic network level by level utilizing the concept clustering unit.

15. The apparatus according to claim 14, characterized in that the apparatus further comprises:
a neighbor concept vector calculation unit for calculating neighbor concept vector of a concept, said neighbor concept vector represents the connection relation between said concept and each concept in said semantic network;
wherein said concept similarity calculation unit uses said neighbor concept vector to calculate the similarities among concepts.

16. The apparatus according to claim 15, characterized in that said concept similarity calculation unit utilizes the dot product of the neighbor concept vectors of said two concepts to calculate the angle between them, the smaller the angle, the higher the similarity between said two concepts.

17. The apparatus according to claim 14, characterized in that the apparatus further comprises:
a hierarchy calculation unit for calculating the number of levels in the hierarchy model to be generated and the number of concepts in each level based on the amount of content in the original semantic network and the maximum capacity of the screen.

18. The apparatus according to claim 14, characterized in that the apparatus further comprises:
a relation type similarity calculation unit for calculating the similarity between a user-specified primary relation type and each relation type in said semantic network.

19. The apparatus according to claim 18, characterized in that the apparatus further comprises:
a relation type feature vector calculation unit for calculating the relation type feature vector for each relation type in said semantic network, wherein each component in said relation type feature vector corresponds to a concept in said semantic network and is calculated based on the connection instance of that relation type associated with said concept.
wherein said relation type similarity calculation unit calculates the similarity between a relation type and said user-specified primary relation type based on the angle between the relation type feature vector of said relation type and the relation type feature vector of said user-specified primary relation type.

20. A semantic network browser, said semantic network comprising a plurality of concepts and a plurality of relation instances each for connecting two concepts, characterized in that said browser comprises:
the apparatus for generating a visualized hierarchy model for a semantic network according to claim 14;
a graph conversion unit for converting the visualized hierarchy model generated by said apparatus for generating a hierarchy model of a semantic network into a graph mode to display; and
a level switching unit for switching between the levels of said hierarchy model and controlling said graph conversion unit to display, in response to user's selection.

21. The semantic network browser according to claim 20, characterized in that said browser further comprises:
a center determination unit for determining a central concept node to be displayed after switching the level of said hierarchy model.

22. An article of manufacture comprising a computer usable medium having computer readable program code means embodied therein for causing generation of a visualized hierarchy model for a semantic network, the computer readable program code means in said article of manufacture comprising computer readable program code means for causing a computer to effect the steps of claim 1.

23. A program storage device readable by machine, tangibly embodying a program of instructions executable by the machine to perform method steps for generating a visualized hierarchy model for a semantic network, said method steps comprising the steps of claim 1.

24. An article of manufacture comprising a computer usable medium having computer readable program code means embodied therein for causing generation of a visualized hierarchy model for a semantic network, the computer readable program code means in said article of manufacture comprising computer readable program code means for causing a computer to effect the steps of claim 11.

25. A program storage device readable by machine, tangibly embodying a program of instructions executable by the machine to perform method steps for browsing a semantic network, said method steps comprising the steps of claim 11.

26. A computer program product comprising a computer usable medium having computer readable program code means embodied therein for causing generation of a visualized hierarchy model for a semantic network, the computer readable program code means in said computer program product comprising computer readable program code means for causing a computer to effect the functions of claim 14.
